(19) United States
(12) Patent Application Publication
(10) Pub. No.: US 2013/0053994 A1
(43) Pub. Date: Feb. 28, 2013

(54) METHOD AND APPARATUS FOR MONITORING RADIOPHARMACEUTICAL PROCESSING

(71) Applicants: Christian Friedrich Peter Rensch, Munich (DE); Victor Donald Samper, Munich (DE); Rajiv Bhalla, Buckinghamshire (GB); Christoph Boeld, Munich (DE); Alexander Jackson, Buckinghamshire (GB); Ruben Julian Horvath-Klein, Munich (DE)

(72) Inventors: Christian Friedrich Peter Rensch, Munich (DE); Victor Donald Samper, Munich (DE); Rajiv Bhalla, Buckinghamshire (GB); Christoph Boeld, Munich (DE); Alexander Jackson, Buckinghamshire (GB); Ruben Julian Horvath-Klein, Munich (DE)

(73) Assignee: GENERAL ELECTRIC COMPANY, Schenectady, NY (US)

(21) Appl. No.: 13/222,409

(22) Filed: Aug. 31, 2011

(51) Int. Cl. G06F 19/00

(52) U.S. Cl. 700/95

(57) ABSTRACT

System and method for monitoring a synthesis process in a synthesizer to provide reduced quality control efforts and facilitate quality by design. The system and method perform by detecting a synthesizer parameter value for one or more synthesizer parameters of a radiopharmaceutical synthesis process in a radiopharmaceutical synthesizer, and comparing the synthesizer parameter value of each of the synthesizer parameters to a corresponding reference synthesizer value range. The radiopharmaceutical synthesis process is either continued, aborted, or interrupted based on a comparison result.

### BACKGROUND

Medical imaging is used extensively to diagnose and treat patients. A number of modalities are well known, such as Magnetic Resonance Imaging (MRI), Computed Tomography (CT), Positron Emission Tomography (PET), and Single Photon Emission Computed Tomography (SPECT). These modalities provide complimentary diagnostic information. For example, PET and SPECT scans illustrate functional aspects of an organ or region of interest.

PET and SPECT are classified as “nuclear” medicine because they measure the emission of a radioactive material which has been injected into a patient. After the radioactive material, e.g., radiopharmaceutical, is injected, it is absorbed by the blood or a particular organ of interest. The patient is then subjected to PET or SPECT detection which measures the emission of the radiopharmaceutical and creates an image from the characteristics of the detected emission. A significant step in conducting PET or SPECT scans is the acquisition and/or the manufacture of the radiopharmaceutical.

The half-lives of these radiopharmaceuticals range from two minutes to two hours, for example. Thus, the injection into the patient and the imaging must take place within a very short time period after production of the radiopharmaceutical. In order to meet the need of the growing practice of using nuclear medicine, portable or compact radiopharmaceutical production devices have been developed, such as the FASTlab® system and the Tracerlab® system, both sold be GE Healthcare, to offer a true multi-tracer or multi-radiopharmaceutical production facility to produce multiple radiotracers without requiring costly expansion of the production areas. In addition, often many radiopharmaceutical production runs or synthesis runs are performed on the device in one day.

Many of these compact synthesizers such as GE's FASTlab® are arranged to operate a single-use cassette, cartridge or chip that is removably mounted to the synthesizer. The spent cassette is removed after the synthesis run and replaced by a fresh cassette. Cassettes may be tailored to produce a specific radiotracer, and the synthesizer is programmed to operate each different type of cassette to synthesize the particular radiotracer.

Quality control (QC) remains a major issue in PET and SPECT radiotracer production since it requires sophisticated equipment, time and trained personnel. Multiple efforts target a reduction of QC efforts such as QC test simplification, elimination or reduction of reagents inappropriate for patient injection and quality by design. In current activity or process monitoring, radiopharmaceutical synthesizers operate in an open loop mode. Hence, the determination as to whether a synthesis has been successful is usually made after the synthesis is completed. The QC analysis is performed post synthesis on the radiopharmaceutical that has been synthesized. Therefore, it is only after the synthesis process is completed that a determination is made as to quality and yield based on QC analysis. Quality control requires sophisticated equipment and is labor, time and cost intensive. In addition, the post-production QC analysis takes time and slows down the process of radiopharmaceutical synthesis, which affects the number and timelines of patients that can be treated.

### BRIEF DESCRIPTION

System and method for monitoring a synthesis process in a synthesizer. The system and method detect a synthesizer parameter value for one or more synthesizer parameters of a radiopharmaceutical synthesis process in a radiopharmaceutical synthesizer, and compare the synthesizer parameter value of each of the synthesizer parameters to a corresponding reference synthesizer value or value range. The radiopharmaceutical synthesis process is either continued, aborted, or interrupted based on a comparison result.

### DRAWINGS

These and other features and aspects of embodiments of the present invention will become better understood when the following detailed description is read with reference to the accompanying drawings in which like characters represent like parts throughout the drawings, wherein:

FIG. 1 is a diagrammatical view of a system for monitoring radiopharmaceutical production according to an embodiment;

FIG. 2 is a diagrammatical view of another system for monitoring radiopharmaceutical production according to another embodiment;

FIG. 3 is a diagrammatical view of sensor array according to an embodiment of the invention;

FIG. 4 illustrates a flow diagram for a process of monitoring radiopharmaceutical production according to an embodiment of the present invention;

FIG. 5 illustrates a flow diagram for another process of monitoring radiopharmaceutical production according to another embodiment of the present invention; and

FIG. 6. Illustrates a flow diagram for another process of monitoring radiopharmaceutical production according to an embodiment of the present invention.

### DETAILED DESCRIPTION

As used herein the terms “cassette,” “cartridge,” “chip,” and “microfluidic chip” will be used interchangeably to mean a permanently installed or interchangeable element containing the full and/or partial fluid path of a device that is configured to produce tracers for use in medical imaging and therapy.

Also, as used herein, “radiopharmaceutical,” “radiotracer,” “tracer,” and “radioactive label,” will be used interchangeably to mean a radioactive compound used in medical imaging and therapy.

Embodiments disclosed herein provide a closed loop control for radioactive on-chip or on-cassette processes, early detection of synthesis failures, reduced quality control efforts through quality by design and radioactive monitoring during processing, where a measurement or sensor array adapts to chips/cassettes with changing design layout without requiring re-assembling, or the addition or removal of certain sensors, such as radioactivity detectors.

Embodiments disclosed herein are directed to increasing system reliability and decreasing quality control efforts by measuring activity levels at multiple points across a cassette or a chip during radiosynthesis over time utilizing a sensor array or multiple sensors. In addition, for increased system integration and downscaling for microfluidic chip-based synthesis devices, activity measurements can be conducted across the disposable cassette or chip utilizing an array of sensors or multiple sensors. Such an assembly can be utilized to measure the current status of a machine and provide early detection of system failures or malfunctions, as well as quantification of synthesis efficiency. In addition, embodiments provide for performance monitoring of single synthesis elements such as drying and purification as a feature for new chemistry development and process debugging, and enable flexibility to various cassette or chip designs which are utilized for different radiotracer syntheses. Quality by design can be achieved by storing the data from the sensors to create a cassette or chip “fingerprint,” or cassette profile. During synthesis, data from the sensors is compared to corresponding reference values or reference value ranges to provide real-time feedback on the quality of the synthesis. The fingerprint or cassette parameter profile could be a single measurement after the end of synthesis or a continuous activity monitoring over time and in parallel to other sequence parameters with respect to the reference value ranges for validation of the product.

According to embodiments disclosed herein, a radioactivity detector array could be realized by semiconductor-based elements such as diodes, diodes in combination with scintillator materials, cadmium zinc telluride (CZT) detectors, MEMS-based detectors, Geiger-Mueller assemblies or combinations thereof arranged in discrete positions across the cassette or chip or as a mesh with a constant or varying pitch between the sensor elements. Depending on the system structure and the sensor technology chosen, alpha, beta (including positrons) and/or gamma radiation can be detected and the information processed within an electronics and software unit of a controller. The operating mode could be binary detection of activity, e.g., true, if activity is within a reference value range, or quantified, e.g., proportional to actual activity level. Substrate materials for a measurement array could be e.g. metals, silicon, glass, polymers, ceramics and low temperature co-fired ceramics (LTCC) or combination of all these.

All chemistry processes that emit radiation are contemplated by embodiments disclosed herein including, but not limited to, nuclear and fluorescent, for example. With respect to nuclear applications, embodiments include, but are not limited to, medical isotopes and corresponding radiation properties such as ¹⁸F, ¹¹C, ¹⁴C, Tc-99m, I-123, I-125, I-131, Ga-68, Ga-67, O-15, N-13, Rb-82, Cu-62, P-32, Sr-89, Sm-153, Re-186, Tl-201, In-111, or combinations thereof. Preferred isotopes include those used for PET such as ¹⁸F, ¹¹C and ⁶⁸Ga.

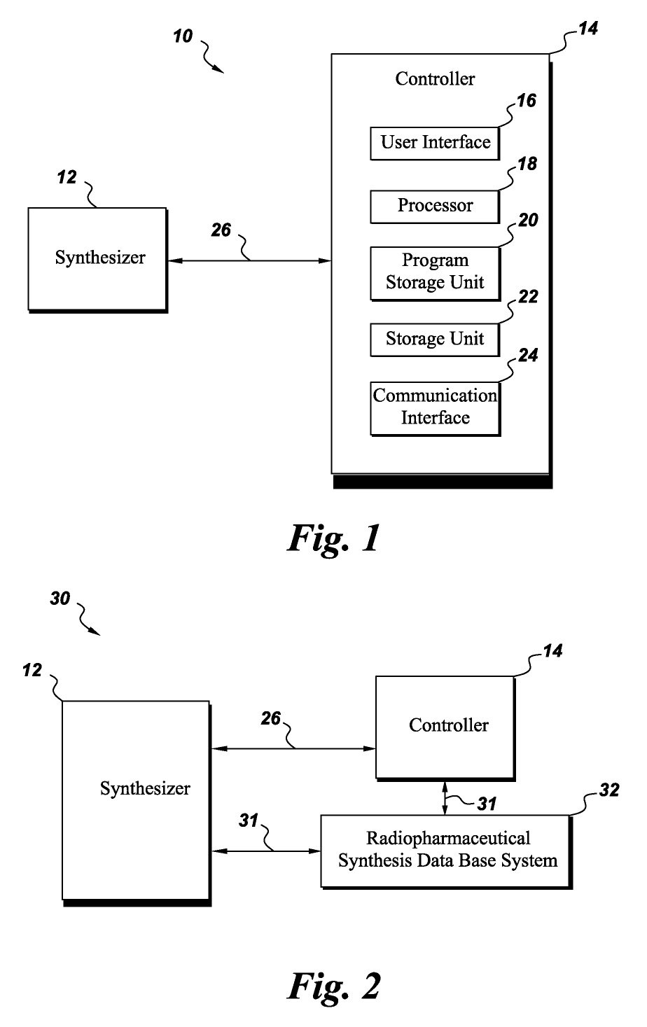

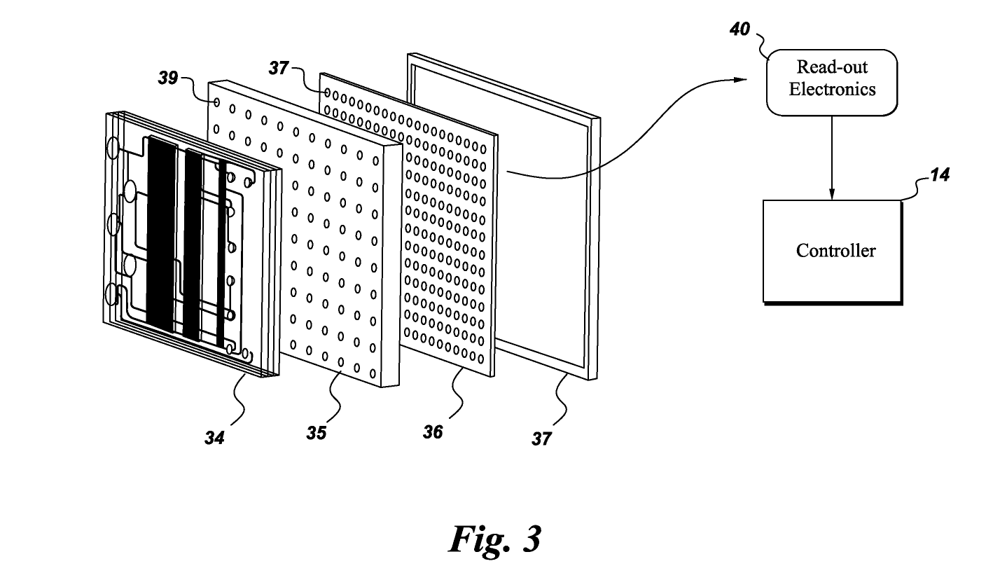

Referring to FIG. 1, a block diagram is shown that provides an overview of a radiopharmaceutical synthesis system. The system 10 includes a synthesizer 12 and a controller 14 having a user interface 16, a processor 18, a program storage unit 20, a storage unit 22, and a communication interface 24. The synthesizer 12 may be any suitable radiopharmaceutical synthesizer such as the FASTlab® sold by GE Healthcare, for example. The synthesizer 12 contains actuators, sensors and a communication system to execute synthesis runs on a cassette/cartridge/chip and measure hardware parameters and sensor outputs which are transmitted to the controller 14. The synthesizer 12 communicates with the controller 14 via a network, including, but not limited to, a Local Area Network (LAN) 26. Any suitable network arrangement can be implemented to provide for communication between the synthesizer 12 and the controller 14 including, but not limited to a wide area network or WAN, such as the Internet. The program storage unit 20 stores radiopharmaceutical synthesizer process programs for synthesizing various radiopharmaceuticals, respectively, as well as other programs as necessary. The storage unit 22 stores information such as, but not limited to, reference values/value ranges for the various sensors in the synthesizer 12, respectively, in addition to synthesis run data output by the sensors during a synthesis run. Each radiopharmaceutical synthesized by the synthesizer 12 will have an associated set of reference values/value ranges for corresponding sensors. These reference values/value ranges can be considered as a “reference fingerprint” of the particular radiopharmaceutical synthesis process and/or cassette. The reference values/value ranges can be programmed into the controller 14 and updated periodically as necessary. The controller 14 and the synthesizer 12 can also receive reference values/value ranges periodically from a radiopharmaceutical synthesis data base system 32 via network 31, such as the Internet, for example, as shown in FIG. 2. The system 32 can be maintained on a local or global database system, on a CD, DVD, USB, or some other storage and processing arrangement. Any suitable communication arrangement can be implemented.

As previously noted, each acquired or measured data can be considered an acquired “fingerprint.” This acquired fingerprint obtained during synthesis runs can be fed into a Failure Modes and Effects Analysis (FMEA), a storage device, or some other comparable quality assurance system, for example, which is maintained on a local and/or global database with potentially multiple contributing hospitals, users and research institutions, for example. In some embodiments, the FMEA can be maintained in the radiopharmaceutical synthesis data base system 32. The controller 14 may reside within the synthesizer 12 or in a remote location. In the current embodiment, the synthesizer 12 includes a controller (not shown) to process the commands and data supplied from controller 14 and the information provided by the radiopharmaceutical synthesis data base system 32. In some embodiments, the controller 14 can be arranged to initiate the real-time synthesis monitoring process and the controller (not shown) within the synthesizer can run the monitoring program.

FIG. 3 illustrates an exemplary embodiment of a sensor arrangement within the synthesizer 12. In this embodiment, a sensor array device 36 is pressed against a mini- and/or microfluidic cassette, cartridge or chip 34 in which chemical processing of PET/SPECT radiotracers is executed. The sensor array device 36 includes radioactivity sensors 37. The radioactive isotope(s) involved in such tracer syntheses emit beta or gamma radiation which is measured by the sensor array 36 and converted into an electric signal that is supplied to the read-out electronics 40. Information from the read-out electronics 40 is supplied to the controller 14. Optionally, the measurement or sensor array 36 can be designed to increase the signal to noise ratio between single array sensor elements 37 by introducing small shielding/radiation compensation sections (e.g., heavy materials or appropriate liquids) between the single sensor elements 37 and between the sensors 37 and the environment. As shown in FIG. 3, a lead mask 35 with through-holes 39 is arranged between the cassette 34 and the sensor array 36. The mask 35 damps out undesired radiation from positions on the chip or cassette 34 not relevant for the local measurement and increases radiation exposure in certain spots on the sensor array 36, thereby increasing the signal to noise ratio for a discrete position on the sensor array 36. In addition, shielding 38 for decreasing the impact of scattered radiation e.g. inside a hot cell environment, can also be provided. The dimensions of optional shielding 38, masking 35, or comparable elements will vary depending on the radiation measured and the sensors utilized. The sensor array 36 can be included in new synthesizers and/or added to existing synthesizers to provide feedback to the controller 14 running the radiopharmaceutical monitoring process. A sensor array is compatible to multiple cassette or chip layouts with reduced design restrictions for future cassette or chip designs.

In other embodiments, multiple radioactivity sensors can be provided in various positions within the synthesizer 12 to measure the radioactivity instead of the sensor array 36 shown in FIG. 3. These radioactivity sensors can be strategically placed to optimize the information gained and to accommodate cassettes having different architectures corresponding to the radiopharmaceutical to be produced. The output of appropriate sensors can be used depending on the cassette and the radiopharmaceutical to be synthesized.

The output from the sensors, and the associated electric signals or information supplied by the read-out electronics 40 provide a fingerprint of where the activity is on the cassette at a certain point in time. The fingerprint is a mapping of the measured location and intensity of radiation on the chip/cassette 34 for a specific point in time or time frame. This information is stored in the storage unit 22. Together with the synthesis sequence that is executed, the synthesizer system 10 can evaluate whether the actually measured results or synthesis run data (“fingerprint”) correlate to a reference value or a reference value range (“reference fingerprint”). As previously noted, the data acquired during synthesis can be fed into a FMEA, which is maintained on a local and/or global database, such as the radiopharmaceutical synthesis data base system 32, with potentially multiple contributing hospitals, users and research institutions. This could have an impact on the reduction of quality control since a large part of the reduction of quality control is based on number of runs that are within reference values/value ranges where batch is released so that you can reduce the number of times quality control processing is performed, once a week, for example. A determination about the output quality and the system performance during radiotracer production can be made prior to the standard quality control, which is performed after synthesis is complete. Embodiments of the invention can lead to quality by design and hence help to reduce subsequent quality control efforts in radiopharmaceutical production.

According to exemplary embodiments, the controller 14 detects when a cassette 34 is fitted or loaded onto the synthesizer 12 and identifies the cassette. The storage unit 22 in the controller can be configured to store cassette information corresponding to identification information provided on the cassette 34. The identification information may include the radiopharmaceutical to be synthesized in the cassette 34 and/or the cassette architecture. The cassette 34 includes identification information such as a bar code, electronic unit or Radio Frequency Identification (RFID), for example, that can be detected by the controller 14. The cassette and/or radiopharmaceutical to be synthesized can be identified by data obtained from other data carriers including, but not limited to, CD, USB FOBs, DVD, network sources, local databases or memories, etc., where the information is not read directly from the cassette, but may be provided by the operator by inserting an extra CD or picking the correct synthesis routine from a database, for example. Any other suitable identification method can be used to enable the cassette 34 to be identified by the controller 14. The controller 14 then retrieves the radiopharmaceutical processing program corresponding to the radiopharmaceutical to be synthesized from the program storage unit 20. The controller 14 also retrieves the corresponding reference value data or reference value range information for the pharmaceutical to be synthesized from the storage unit 22. The controller 14 can also selectively activate and/or identify the sensors 37 of the sensor array 36 (or the sensors from a group of sensors arranged in the synthesizer 12) that will be needed to monitor the synthesis of the radiopharmaceutical in the particular cassette 34 based on the cassette information.

In addition to the radioactivity sensors discussed in the exemplary embodiments, other sensors are provided in the synthesizer 12 to detect other parameters including, but not limited to, syringe pump positions, fluid levels, valve positions, pressures, temperatures, flow rates, volumes, fluorescence, fluid clarity and optical testing, pH testing, electrical voltages or currents, magnetic and electric fields, process times, and user modifications, for example. The output of each sensor corresponds to associated reference data such as a reference value or reference value range. The data from these sensors can also be included in the “fingerprint” or information supplied to the controller and can also be compared with corresponding reference sensor values or value ranges to provide even more information of the synthesis process.

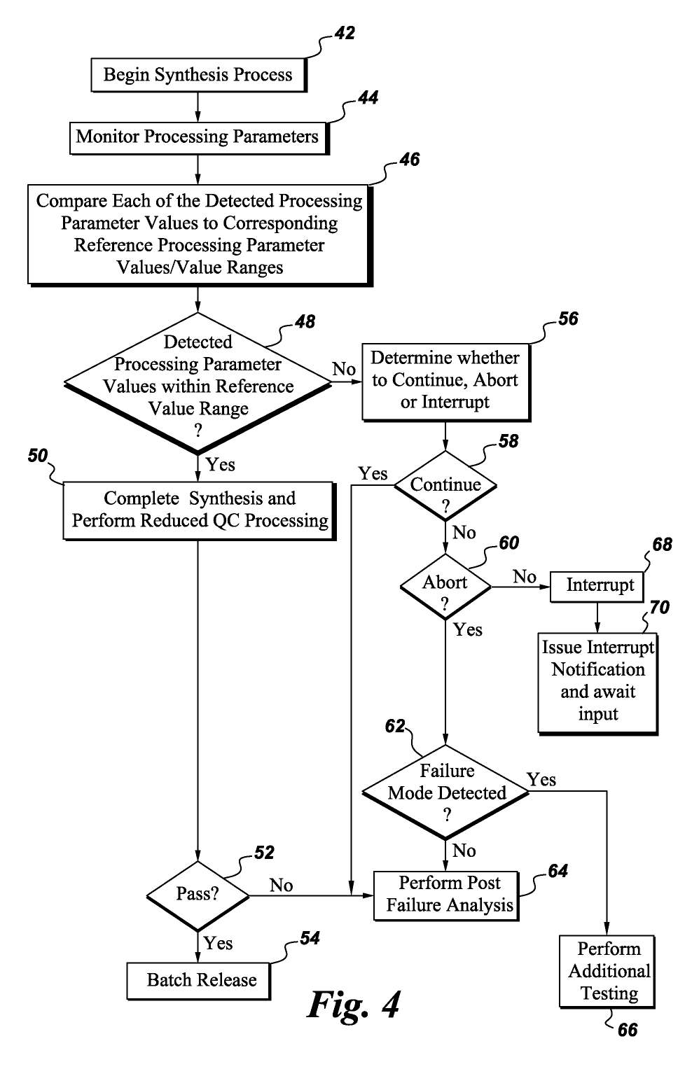

FIG. 4 shows a flow diagram for real-time synthesizer monitoring process according to an exemplary embodiment. In step 42, the synthesis process for a desired radiopharmaceutical begins. The particular radiopharmaceutical and associated synthesizer processing program can be programmed into the controller 14 or determined based on the detection of the type of cassette 34 arranged within the synthesizer 12 as detected by the controller 14, either by identification information on the cassette 34 or from another data carrier as previously discussed. Any suitable method for selecting the appropriate synthesizer processing program can be implemented. In step 44, processing parameters are monitored based on sensor output. These parameters can include radioactivity levels, temperature, gas pressure, system pressures, valve positions, as well as any other parameter useful to determining the quality of the process. The monitoring step includes receiving data from the actuators, sensors and/or detectors that detect the parameter values at various stages in the synthesizing process. There may be multiple sensors to detect a particular parameter at the various stages of processing. As data is received from each of the sensors, the data is compared to a corresponding reference value or a reference value range in step 46. For ease of description only, comparison with reference value ranges will be described. In step 48, it is determined whether the detected parameter value of each of the parameters is within the corresponding reference value range. If the data is within the reference value range, then processing continues to step 50 where the synthesis process is completed and a reduced set of quality control tests is performed. If the radiopharmaceutical produced by the synthesis process passes the reduced set of quality control tests in step 52 then the product or batch is released in step 54. If the radiopharmaceutical produced by the synthesis process does not pass the reduced set of quality control tests in step 52, then post failure analysis testing is performed in step 64. If the data is not within the corresponding reference value range in step 48, then processing continues to step 56 where it is determined whether to continue, abort or interrupt the synthesis process. If the decision in step 58 is to continue synthesis, then processing proceeds to step 64. If the decision in step 58 is not to continue the synthesis, then processing continues to step 60 where it is determined whether to abort the synthesis. If the synthesis process is aborted in step 60, then processing continues to step 62. In step 62, it is determined whether a failure mode has been detected indicating where and/or why the synthesis had to be aborted. Failure modes may include for example, but not limited to, pressure drops due to system leakage, pressure increases due to clogging, high activity concentrations in areas of the system where there should be no high activity concentrations (e.g. due to leakage) false fluid levels, valve or actuator stalling, air bubbles, delivery failure from external systems to the synthesizer such as empty gas bottles or blocked lines, for example. Early process abortion and failure mode identification may be a cost and time saver, since a synthesis run could be repeated prior to the final quality control testing which adds another hour to the radiopharmaceutical production process. If a failure mode is detected in step 62, then processing continues to step 66 and additional testing corresponding to the failure mode is performed. In some embodiments, the failure data that is detected can be supplied to a central database, centralized FMEA or central control (not shown), such as the radiopharmaceutical synthesis data base system 32, to provide an additional level of control and compliance. If a failure mode is not detected in step 62, then post failure analysis testing is performed in step 64. If the answer is no in step 60, then the synthesis process is interrupted in step 68 and processing continues to step 70. In step 70, an interrupt notification is issued indicating that the system is on hold awaiting input.

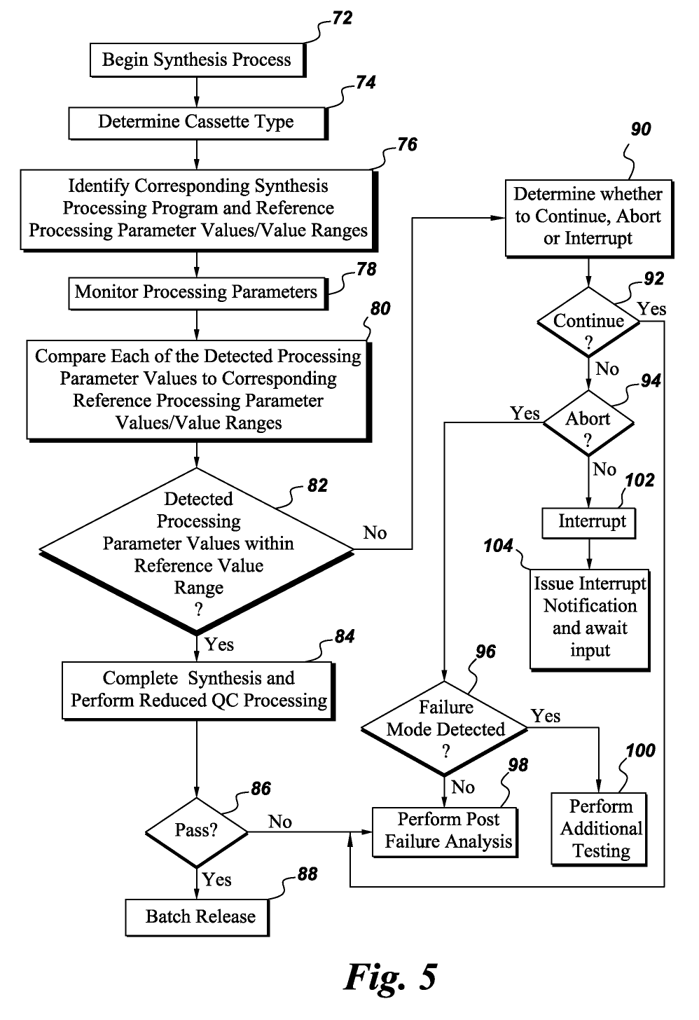

FIG. 5 shows a flow diagram for a real-time synthesizer monitoring process according to another exemplary embodiment. In step 72, the synthesis process for a desired radiopharmaceutical begins. In step 74, the cassette is detected and identified based on the cartridge information detected by the controller 14. In step 76, the radiopharmaceutical synthesis program for the radiopharmaceutical to be produced on the cassette 34 is retrieved as well as the reference value data for the cassette. The remaining steps correspond to steps 44-70 in FIG. 4. More particularly, in step 78, processing parameters are monitored. As data is received from each of the sensors, the data is compared to a corresponding reference value or a reference value range in step 80. In step 82, it is determined whether the data is within the corresponding reference value range. If the data is within the reference value range, then processing continues to step 84 where the synthesis process is completed and a reduced set of quality control tests is performed. If the radiopharmaceutical produced by the synthesis process passes the reduced set of quality control tests in step 86 then the product or batch is released in step 88. If the radiopharmaceutical produced by the synthesis process does not pass the reduced set of quality control tests in step 86, then post failure analysis testing is performed in step 98. If the data is not within the corresponding reference value range in step 82, then the synthesis process continues to step 90 where it is determined whether to continue, abort, or interrupt the synthesis process. If the synthesis process is continued in step 92, then processing continues to step 98. If it is determined not to continue the synthesis process in step 92, then processing continues to step 94 where it is determined whether the process should be aborted. If the answer in step 94 is yes, then the synthesis process is aborted and processing continues to step 96. In step 96, it is determined whether a failure mode has been detected indicating where and/or why the synthesis had to be aborted. If a failure mode is detected in step 96, then processing continues to step 100 and additional testing corresponding to the failure mode is performed. If a failure mode is not detected in step 96, then post failure analysis testing is performed in step 98. If the answer is no in step 94, then the synthesis process is interrupted in step 102 and processing continues to step 104. In step 104, an interrupt notification is issued indicating that the system is on hold awaiting input.

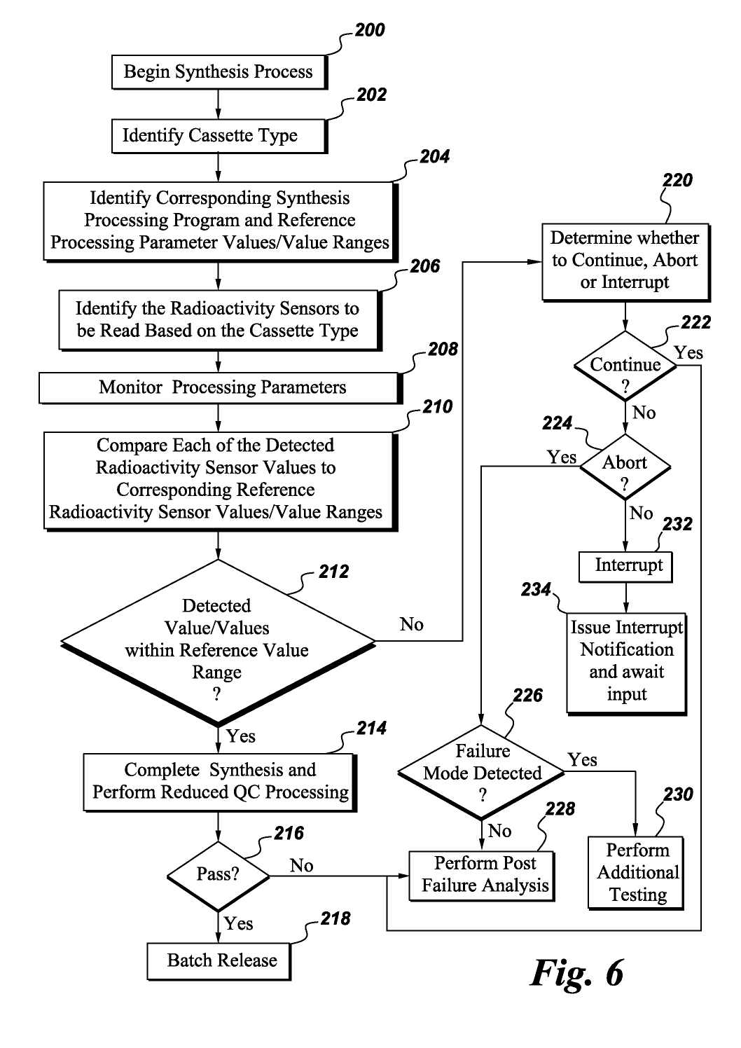

The processes in both FIGS. 4 and 5 can each further include selectively activating sensors or reading the output from selected sensors based on the radiopharmaceutical to be synthesized prior to executing the monitoring steps 44 and 78. FIG. 6 shows a flow diagram of another exemplary embodiment, including the step of reading the output of selected sensors. In addition, the embodiment shown in FIG. 6 is a process for reading the output of radioactive sensors, as discussed with respect to FIG. 3. However, the process shown in FIG. 6 can be implemented using sensor information for other synthesis parameters as well, as disclosed in previous embodiments.

Referring to FIG. 6, the synthesis process is initiated in step 200. In step 202, the cassette type is identified based on the cassette information detected by the controller 14. In step 204, the radiopharmaceutical synthesis program for the radiopharmaceutical to be produced on the detected cassette 34 is retrieved as well as the reference value data corresponding to the radiopharmaceutical synthesis program. In step 206, the radioactivity sensors that are to be read or from which data will be used in the radiopharmaceutical synthesis program are identified based on the cassette information. In step 208, output from the radioactivity sensors is monitored throughout the synthesis process. As data is received from each of the radioactivity sensors, the data is compared to a corresponding reference value or a reference value range in step 210. For ease of description only, comparison with reference value ranges will be described. In step 212, it is determined whether the data is within the corresponding reference value range. If the data is within the reference value range, then processing continues to step 214 where the synthesis process is completed and a reduced set of quality control tests is performed. If the radiopharmaceutical produced by the synthesis process passes the reduced set of quality control tests in step 216 then the product or batch is released in step 218. If the radiopharmaceutical produced by the synthesis process does not pass the reduced set of quality control tests in step 216, then post failure analysis testing is performed in step 228. If the data is not within the corresponding reference value range in step 212, then processing continues to step 220 where it is determined whether to continue, abort or interrupt the synthesis process. If the decision is to continue processing in step 222, then processing continues to step 228. If the decision in step 222 is no, then it is determined whether to abort the process in step 224. If the synthesis process is aborted, then processing continues to step 226. In step 226, it is determined whether a failure mode has been detected indicating where and/or why the synthesis had to be aborted. If a failure mode is detected in step 226, then processing continues to step 230 and additional testing corresponding to the failure mode is performed. If a failure mode is not detected in step 226, then post failure analysis testing is performed in step 228. If the answer in step 224 is no, then the synthesis is interrupted in step 232 and processing continues to step 234. In step 234, an interrupt notification is issued indicating that the system is on hold awaiting input.

As described herein, embodiments of the invention provide for closed-loop, real-time monitoring of a radiopharmaceutical synthesis process based on information received from sensors and actuators in the synthesizer. The real-time monitoring allows the system to abort a synthesis process as soon as data from a sensor somewhere in the process detects an error based on the reference value/value ranges. Cost and time are saved by aborting as soon as an error is detected. The embodiments also provide a quantification of the synthesis efficiency. In addition, the embodiments disclosed herein enable flexibility to various cassette or chip designs which are utilized for different radiotracer syntheses, respectively. The multiple sensor and/or the sensor array structure can be applied for the measurement of cassettes of different designs and layouts for varying radiotracers to be synthesized on respective specialized cassettes. Embodiments of the invention also help to reduce quality control efforts after the synthesis is completed by providing an activity or parameter measurement during processing and allowing for early detection of system failures and synthesis assessment. The data from the sensors that is stored can be used as a “fingerprint” of a cartridge, cassette or chip. Fingerprint collection and synchronization with FMEAs ensures improved confidence intervals for radiopharmaceutical processing and may lead to further reduction of quality control efforts.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method, comprising:
detecting a synthesizer parameter value for one or more synthesizer parameters of a radiopharmaceutical synthesis process in a radiopharmaceutical synthesizer;
comparing the synthesizer parameter value of each of the synthesizer parameters to a corresponding reference synthesizer value range;
determining whether to continue, abort or interrupt the radiopharmaceutical synthesis process when the synthesizer parameter value of at least one of the one or more synthesizer parameters is outside of the corresponding reference synthesizer value range; and
controlling the radiopharmaceutical synthesis process based on a determination result.

2. The method of claim 1, wherein the comparing step is performed continuously.

3. The method of claim 1, wherein the synthesizer parameters include at least one of radioactivity levels, syringe pump positions, fluid levels, valve positions, pressures, temperatures, flow rates, volumes, fluorescence, fluid clarity, pH, voltages, currents, magnetic and electric fields, process times, and user modifications.

4. The method of claim 1, further comprising:
performing a first set of final quality control tests on a radiopharmaceutical synthesized by the synthesizer when each of the synthesizer parameter values measured in process is within the corresponding reference synthesizer value range; and
performing a second set of final quality control tests on the radiopharmaceutical synthesized by the synthesizer when each of the synthesizer parameter values measured in process is outside of the corresponding reference synthesizer value range;
wherein the first set is less than the second set.

5. The method of claim 1, further comprising:
detecting a failure mode when the synthesizer parameter value of at least one of the one or more synthesizer parameter values is outside of the corresponding reference synthesizer value range; and
generating failure data corresponding to the failure mode detected.

6. The method of claim 1, further comprising:
storing synthesizer parameter values for the one or more synthesizers in a storage unit.

7. The method of claim 6, further comprising:
supplying the synthesizer parameter values stored in the storage unit to at least one of a Failure Modes and Effects Analysis (FMEA) unit, a storage device, a radiopharmaceutical synthesis data base system, or quality assurance system.

8. The method of claim 7, wherein the FMEA unit is stored in radiopharmaceutical synthesis data base system.

9. A method, comprising:
identifying a radiopharmaceutical cassette arranged in the radiopharmaceutical synthesizer;
selecting a radiopharmaceutical synthesis program as well as a reference synthesizer value range for each of one or more synthesizer parameters of the radiopharmaceutical synthesis process from a storage unit database based on the radiopharmaceutical cassette identified;
detecting a synthesizer parameter value for the one or more synthesizer parameters of the radiopharmaceutical synthesis process;
comparing the synthesizer parameter value of each of the one or more synthesizer parameters to a corresponding reference synthesizer value range;
determining whether to continue, abort or interrupt the radiopharmaceutical synthesis process when the synthesizer parameter value of at least one of the one or more synthesizer parameters is outside of the corresponding reference synthesizer value range; and
controlling the radiopharmaceutical synthesis process based on a determination result.

10. The method of claim 9, wherein identifying the radiopharmaceutical cassette comprises detecting identification information arranged on the radiopharmaceutical cassette.

11. The method of claim 10, wherein identifying the radiopharmaceutical cassette further comprises detecting radiopharmaceutical synthesis process information stored on the radiopharmaceutical cassette.

12. The method of claim 9, wherein the comparing step is performed continuously.

13. The method of claim 9, wherein the one or more synthesizer parameters include at least one of radioactivity levels, syringe pump positions, fluid levels, valve positions, pressures, temperatures, flow rates, volumes, fluorescence, fluid clarity, pH, voltages, currents, magnetic and electric fields, process times, and user modifications.

14. The method of claim 9, further comprising:
selecting a sensor arrangement in the radiopharmaceutical synthesizer for at least one of the one or more synthesizer parameters based on the radiopharmaceutical cassette detected.

15. The method of claim 14, wherein selecting the sensor arrangement comprises:
selecting an arrangement of radioactivity sensors to detect radioactivity levels at multiple stages of the radiopharmaceutical synthesis process.

16. The method of claim 9, further comprising:
Selecting radioactivity sensors from a sensor array from which radioactivity levels at multiple stages of the radiopharmaceutical process will be detected.

17. A method, comprising:
detecting a radioactivity level at multiple stages of a radiopharmaceutical synthesis process in a radiopharmaceutical synthesizer for synthesizing radiopharmaceuticals;
comparing the radioactivity level at each of the multiple stages to a corresponding reference radioactivity value range; and
determining whether to continue, abort or interrupt the radiopharmaceutical synthesis process when the radioactivity level at one or more of the multiple states is outside of the corresponding reference radioactivity value range; and
controlling the radiopharmaceutical synthesis process based on a determination result.

18. The method of claim 17, wherein the comparing step is performed continuously.

19. The method of claim 17, further comprising:
completing the radiopharmaceutical synthesis process when the radioactivity level at each of the multiple stages is within the corresponding reference radioactivity value range.

20. The method of claim 17, further comprising:
identifying a radiopharmaceutical to be synthesized by the radiopharmaceutical synthesizer; and
selecting a sensor arrangement for detecting the radioactivity level at each of the multiple stages in the radiopharmaceutical process based on the radiopharmaceutical identified.

21. The method of claim 20, wherein selecting the sensor arrangement comprises:
selectively activating one or more sensors of the sensor arrangement.

22. The method of claim 17, further comprising:
accessing a synthesizer reference value database;
selecting the corresponding reference radioactivity value ranges based on the radiopharmaceutical process running on the radiopharmaceutical synthesizer.

23. The method of claim 17, further comprising:
accessing a program storage unit arranged to store radiopharmaceutical processes associated with radiopharmaceuticals, respectively;
selecting one of the radiopharmaceutical processes associated with a radiopharmaceutical to be synthesized.

24. The method of claim 17, further comprising:
identifying a radiopharmaceutical cassette arranged in the radiopharmaceutical synthesizer; and
selecting the corresponding reference radioactivity values from a storage unit database based on the radiopharmaceutical cassette identified.

25. The method of claim 24, further comprising:
selecting a sensor arrangement in the radiopharmaceutical synthesizer based on the radiopharmaceutical cassette identified.

26. A radiopharmaceutical synthesizer, comprising:
a receiver configured to receive a radiopharmaceutical cassette;
radioactivity sensors arranged at multiple points corresponding to locations of radiopharmaceutical synthesis processing in the radiopharmaceutical cassette to output radioactivity levels at each of the multiple points; and
a controller configured to control the radioactivity sensors based upon a radiopharmaceutical to be synthesized in the radiopharmaceutical cassette.

27. The radiopharmaceutical synthesizer of claim 26, wherein the radioactivity sensors are configured in an array of radioactivity sensors.

28. The radiopharmaceutical synthesizer of claim 26, further comprising sensors for detecting at least one of east one of syringe pump positions, fluid levels, valve positions, pressures, temperatures, flow rates, volumes, fluorescence, fluid clarity, pH, voltages, currents, magnetic and electric fields, process times, and user modifications.

29. The radiopharmaceutical synthesizer of claim 26, wherein the pharmaceutical synthesizer is configured to receive radiopharmaceutical cassettes having different architectures, respectively, for synthesizing associated radiopharmaceuticals, and wherein the controller identifies the radiopharmaceutical cassette and selectively reads one or more of the radioactivity sensors based on the radiopharmaceutical cassette identified.

30. A radiopharmaceutical synthesizer, comprising:
a receiver configured to receive a radiopharmaceutical cassette;
sensors arranged at multiple points corresponding to locations of radiopharmaceutical synthesis processing in the radiopharmaceutical cassette to detect a synthesis parameter value for one or more synthesis parameters at each of the multiple points;
a storage unit to store reference synthesizer value ranges for each of the sensors; and
a controller configured to receive the synthesis parameter value from each of the sensors and to continue, abort or interrupt the radiopharmaceutical synthesis process based upon a comparison of each synthesis parameter value for each of the one or more synthesis parameters with corresponding reference synthesizer value ranges accessed from the storage unit.

31. The radiopharmaceutical synthesizer of claim 30, wherein the sensors comprise an array of radioactivity sensors.

32. The radiopharmaceutical synthesizer of claim 31, wherein the controller is configured to receive the output from selected sensors in the sensor array based on a radiopharmaceutical synthesized on the radiopharmaceutical cassette.

33. The radiopharmaceutical synthesizer of claim 30, wherein the controller is configured to:
identify the radiopharmaceutical cassette arranged in the radiopharmaceutical synthesizer; and
select the reference synthesizer value ranges from the storage unit based on the radiopharmaceutical cassette identified.

34. The radiopharmaceutical synthesizer of claim 30, wherein the synthesizer parameters include at least one of radioactivity levels, syringe pump positions, fluid levels, valve positions, pressures, temperatures, flow rates, volumes, fluorescence, fluid clarity, pH, voltages, currents, magnetic and electric fields, process times, and user modifications.

35. A non-transitory computer-readable medium comprising computer-readable instructions of a computer program that, when executed by a processor, cause the processor to perform a method, the method comprising:
detecting a synthesizer parameter value for one or more synthesizer parameters of a radiopharmaceutical synthesis process in a radiopharmaceutical synthesizer;
comparing the synthesizer parameter value of each of the synthesizer parameters to a corresponding reference synthesizer value range;
determining whether to continue, abort or interrupt the radiopharmaceutical synthesis process when the synthesizer parameter value of at least one of the one or more synthesizer parameters is outside of the corresponding reference synthesizer value range; and
controlling the radiopharmaceutical synthesis process based on a determination result.
